(19) United States
(12) Patent Application Publication
(10) Pub. No.: US 2012/0042645 A1
(43) Pub. Date: Feb. 23, 2012

(54) CONTROL DEVICE FOR STIRLING ENGINE

(75) Inventors: Masaaki Katayama, Susono-shi (JP); Daisaku Sawada, Gotemba-shi (JP); Hiroshi Yaguchi, Susono-shi (JP)

(73) Assignee: TOYOTA JIDOSHA KABUSHIKI KAISHA, Toyota-Shi (JP)

(21) Appl. No.: 13/198,242

(22) Filed: Aug. 4, 2011

(30) Foreign Application Priority Data
Aug. 20, 2010 (JP) 2010-185605

(51) Int. Cl. F02G 1/04

(52) U.S. Cl. 60/525

(57) ABSTRACT

A control device for a Stirling engine including: two cylinder units; and a decompression portion that brings about a decompression effect of reducing a degree of compression of a working fluid that flows back and forth between the two cylinder units, by letting out the working fluid that flow back and forth between the two cylinder units, when the Stirling engine is started; the control device including a control portion that controls the decompression portion so that the decompression effect is gradually weakened after the Stirling engine is started.

### CROSS-REFERENCE TO RELATED APPLICATIONS

This application claims priority to Japanese Patent Application No. 2010-185605 filed on Aug. 20, 2010, which is incorporated herein by reference in its entirety including the specification, drawings and abstract.

### BACKGROUND OF THE INVENTION

1. Field of the Invention

The invention relates to a control device for a Stirling engine and, more particularly, to a Stirling engine control device that is provided for a Stirling engine constructed so as to obtain a decompression effect of reducing the degree of compression of the working fluid.

2. Description of Related Art

In recent years, Stirling engines are drawing attention as a measure to recover exhaust heat from an internal combustion engine mounted in a vehicle, such as a passenger car, a bus, a truck, etc., or exhaust heat from a factory. The Stirling engine can be expected to achieve high heat efficiency. Furthermore, since the Stirling engine is an external combustion engine in which working fluid is heated from outside, the Stirling engine also has an advantage of being able to utilize practically any heat source available, that is, being able to utilize varieties of low-temperature-difference alternative energy forms, such as solar heat, terrestrial heat, exhaust heat, etc., and of contributing to energy conservation. A technology that is considered to be relevant to this invention in that, to start a Stirling engine, the working fluid is discharged to the outside of the Stirling engine so as to obtain the decompression effect is disposed in, for example, Japanese Patent Application Publication No. 2009-127476 (JP-A-2009-127476). Furthermore, Japanese Patent Application Publication No. 05-38956 (JP-A-05-38956) is considered to be relevant to the invention in that a technology related to the starting of a Stirling engine. Besides, Japanese Patent Application Publication No. 2005-299594 (JP-A-2005-299594) is considered to be relevant to the invention in that a technology related to the decompression effect is disclosed.

In the technology disclosed in Japanese Patent Application Publication No. 2009-127476 (JP-A-2009-127476), when the self-sustaining operation of the Stirling engine has started, the discharge of the working fluid is stopped. Therefore, in this technology, at the time of start of the self-sustaining operation at which the rotational speed of the Stirling engine has risen, the working fluid is suddenly retained in a working space as the decompression effect discontinues. Consequently, it is considered that this technology may sometimes bring about occurrence of a torque fluctuation that exceeds a permissible torque fluctuation. Concretely, as shown in FIG. 6, for example, while the permissible torque fluctuation is a torque fluctuation between a maximum torque Tₘₐₓ and a minimum torque Tₘᵢₙ with an average torque Tₘ being the middle point therebetween, a torque fluctuation in which the torque fluctuates to a torque T′ₘₐₓ that exceeds the maximum torque Tₘₐₓ occurs at the time of an instantaneous stop of the decompression effect.

### SUMMARY OF THE INVENTION

The invention provides a Stirling engine control device capable of preventing or restraining a torque fluctuation greater than a permissible torque fluctuation from occurring in association with discontinuation of the decompression effect.

A control device for a Stirling engine in accordance with a first aspect of the invention includes: two cylinder units; and a decompression portion that brings about a decompression effect of reducing a degree of compression of a working fluid that flows back and forth between the two cylinder units, by letting out the working fluid that flow back and forth between the two cylinder units, when the Stirling engine is started; the control device including a control portion that controls the decompression portion so that the decompression effect is gradually weakened after the Stirling engine is started.

A control device for a Stirling engine in accordance with a second aspect of the invention includes: two cylinder units made up of a high-temperature cylinder unit that includes a high-temperature cylinder and a high-temperature piston that is gas-lubricated with respect to the high-temperature cylinder, and a low-temperature cylinder unit that includes a low-temperature cylinder and a low-temperature piston that is gas-lubricated with respect to the low-temperature cylinder; a crankcase provided with a crankshaft that converts reciprocating motion of the high-temperature piston and the low-temperature piston into rotational motion; a communication portion that communicates the interior of the crankcase with a working space in which a working fluid that flows back and forth between the two cylinder units is present; and a flow amount adjustment valve that is interposed in the communication portion; the control device including a control portion that executes a control to open the flow amount adjustment valve when the Stirling engine is being started, and to gradually close the flow amount adjustment valve after the Stirling engine is started.

According to the foregoing aspects of the invention, it is possible to prevent or restrain a torque fluctuation greater than a permissible torque fluctuation from occurring in association with discontinuation of the decompression effect.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing an ECU 80 that is a control device in accordance with an embodiment of the invention, together with a Stirling engine;

FIG. 2 is a diagram showing in a flowchart an operation of the ECU in accordance with the embodiment of the invention;

FIG. 3 is a diagram showing torque fluctuation in accordance with the embodiment of the invention;

FIG. 4 is a diagram showing portions of a Stirling engine in accordance with a modified embodiment of the invention;

FIG. 5 is a diagram showing in a flowchart an operation of an ECU to control the Stirling engine in accordance with the modification of the invention; and

FIG. 6 is a diagram showing torque fluctuation in association with instantaneous discontinuation of the decompression effect according to the related art.

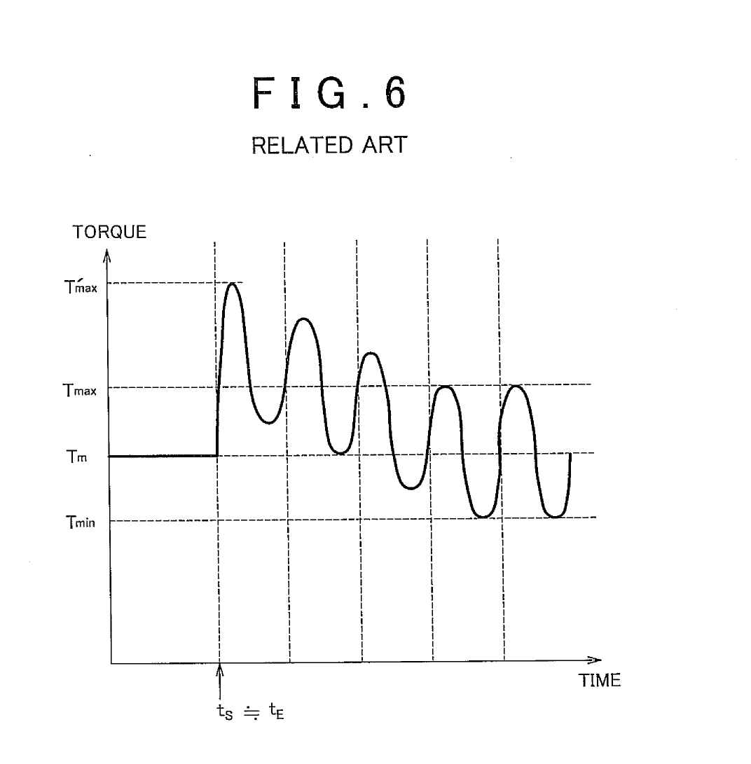

### DETAILED DESCRIPTION OF EMBODIMENTS

Hereinafter, embodiments of the invention will be described in detail with reference to the drawings.

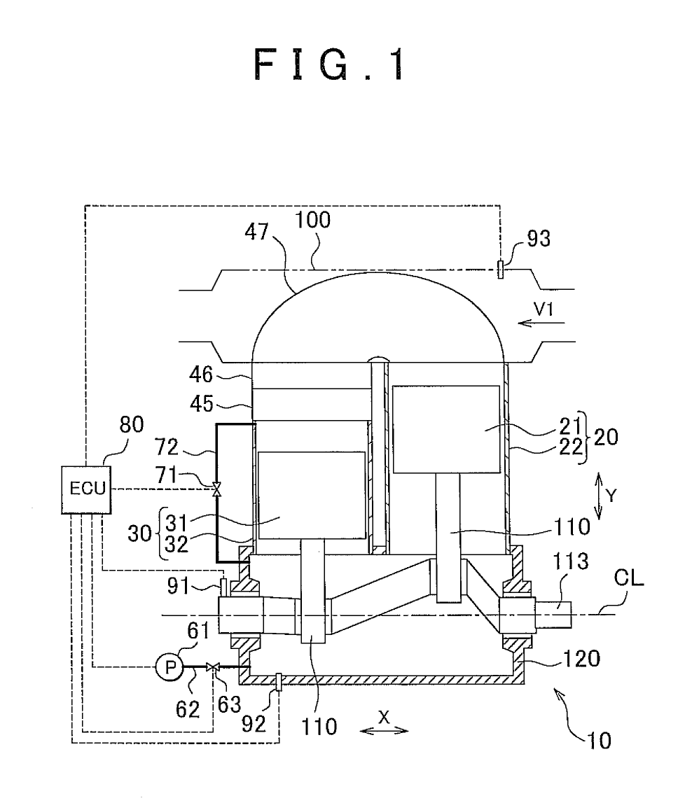

FIG. 1 is a diagram showing an ECU 80, which serve as the control device for a Stirling engine in accordance with an embodiment of the invention, together with a Stirling engine 10. The Stirling engine 10 is a two-cylinder α-type Stirling engine. The Stirling engine 10 includes a pair of cylinder units, specifically, a high-temperature cylinder unit 20 and a low-temperature cylinder unit 30, which are disposed in an in-line parallel arrangement such that a cylinder arrangement direction X of the cylinders is parallel to an extending direction of a crankshaft line CL. The high-temperature cylinder unit 20 has an expansion piston 21 that serves as a high-temperature piston, and a high-temperature cylinder 22. The low-temperature cylinder unit 30 has a compression piston 31 that serves as a low-temperature piston, and a low-temperature cylinder 32. The reciprocating phase of the compression piston 31, which reciprocates within the low-temperature cylinder 32, differs from that of the expansion piston 21, which reciprocates within the high-temperature cylinder 22, so that the compression piston 31 lags behind the expansion piston 21 by about 90° in crank angle. The reciprocating motion of the pistons 21 and 31 are transmitted via connecting rods 110 to a crankshaft 113 that is provided within the crank case 120, and is thereby converted into rotational motion.

An upper space in the high-temperature cylinder 22 is an expansion space. A working fluid heated by a heater 47 flows into the expansion space. Concretely, in this embodiment, the heater 47 is disposed within an exhaust pipe 100 of a gasoline engine that is mounted in a vehicle. In connection with this respect, the Stirling engine 10 is disposed so that the extending direction of the crankshaft line CL (i.e., the cylinder arrangement direction X) is parallel to a flowing direction V1 of exhaust gas. In the heater 47, the working fluid is heated by thermal energy that is recovered from exhaust gas that is a fluid that constitutes a high-temperature heat source. An upper space in the low-temperature cylinder 32 is a compression space. The working fluid cooled by a cooler 45 flows into the compression space. A regenerator 46 exchanges heat with the working fluid that moves back and forth between the expansion space and the compression space, which are working spaces. Specifically, the regenerator 46 absorbs heat from the working fluid when the working fluid flows from the expansion space to the compression space, and releases stored heat to the working fluid when the working fluid flows from the compression space to the expansion space. The working fluid used in this embodiment is air. However, other gasses may also be used as the working fluid, such as He, H₂, N₂, etc.

Next, the operation of the Stirling engine 10 will be described. As the working fluid is heated by the heater 47, the working fluid expands to push the expansion piston 21 down, whereby the crankshaft 113 is pivoted. Next, as the expansion piston 21 transitions into an ascending stroke, the working fluid is moved into the regenerator 46 through the heater 47. The working fluid releases heat to the regenerator 46, and then flows out into the cooler 45. The working fluid cooled by the cooler 45 flows into the compression space, and then is compressed as the compression piston 31 ascends. The thus compressed working fluid now flows into the heater 47 through the generator 46 while absorbing heat from the regenerator 46, so that the temperature of the working fluid rises. In the heater 47, the working fluid is heated and expands again. That is, through the reciprocating flowage of the working fluid in this manner, the Stirling engine 10 is operated.

Accordingly, in this embodiment, because the heat source of the Stirling engine 10 is exhaust gas from the internal combustion engine of the vehicle, the obtainable amount of heat is restricted, and therefore the Stirling engine 10 needs to be operated within the obtainable amount of heat. In the embodiment, therefore, the internal friction of the Stirling engine 10 is reduced as much as possible. Specifically, in order to minimize the frictional losses caused by a piston ring which is the greatest of the losses caused by the internal frictions of the Stirling engines, gas lubrication is adopted between the cylinders 22 and 32 and the pistons 21 and 31, respectively.

In the gas lubrication, the pistons 21 and 31 are floated in air by utilizing the pressure (distribution) of air that occurs in small clearances between the cylinders 22 and 32 and the pistons 21 and 31. Since the gas lubrication in which an object is floated in air causes only a very small sliding resistance, the internal friction of the Stirling engine 10 can be considerably reduced. For the gas lubrication in which an object is floated in air, it is possible to apply, for example, a hydrostatic gas lubrication in which a pressurized fluid is jetted and the thus produced hydrostatic pressure is used to float the object. However, this is not restrictive, but the gas lubrication may also be, for example, a hydrodynamic gas lubrication.

The clearance between the cylinders 22 and 32 and the pistons 21 and 31 in the gas lubrication has a size of several ten micrometers. In the clearance, there exists the working fluid of the Stirling engine 10. Due to the gas lubrication, the pistons 21 and 31 are supported in a state of non-contact with the cylinders 22 and 32, respectively, or in a state of allowable contact with the cylinders 22 and 32. Therefore, a piston ring is not provided around either of the pistons 21 and 31, and the lubricating oil that is used together with a piston ring in a common lubrication method is not used. In the gas lubrication, the air-tightness of the expansion space and of the compression space is maintained by the small clearances, and the clearance seal is established in a ring-less and oil-less manner.

In the Stirling engine 10, the interior of the crankcase 120 may be pressurized in order to increase output. In order to pressurize the interior of the crankcase 120, the Stirling engine 10 further includes a pressurizing pump 61, a pressurization-purpose piping 62 and a pressurization-purpose open-close valve 63. The pressurizing pump 61 serves as pressurization means for pressurizing the inside of the crankcase 120, and the pressurization-purpose piping 62 serves as connection means for connecting the pressurizing pump 61 and the crankcase 120. The pressurization-purpose open-close valve 63 is provided in an intermediate portion of the pressurization-purpose piping 62, and serves as switch means for switching between the permission and the prohibition of the pressurization of the inside of the crankcase 120.

In the Stirling engine 10, when the interior of the crankcase 120 is pressurized, the average pressure of the working fluid present in the expansion space and in the compression space gradually becomes equalized with the average pressure the average pressure of the working fluid present in the crankcase 120 due to the small clearances formed between the pistons 21 and 31 and the cylinders 22 and 32. Therefore, in the Stirling engine 10, the interior of the crankcase 120 is pressurized to make the pressure of the working fluid high so that the working fluid is sufficiently pressurized.

Besides, the Stirling engine 10 is constructed so that a decompression effect is obtained, in order to reduce the engine-starting torque. In order to bring about the decompression effect, the Stirling engine 10 further includes a decompression valve 71 and a bypass pipe 72. The decompression valve 71 is provided in an intermediate portion of the bypass pipe 72, and serves as decompression means for bringing about the decompression effect of reducing the degree of compression of the working fluid that flows back and forth between the cylinder units 20 and 30 by letting out the working fluid that flow back and forth between the cylinder units 20 and 30. Specifically, the decompression valve 71 is constructed so as to allow the working fluid that flows back and forth between the cylinder units 20 and 30 to move back and forth between the working space and the inside of the crankcase 120.

The bypass pipe 72 is communication means for providing communication between the inside of the crankcase 120 and the working space in which the working fluid that flows back and forth between the cylinder units 20 and 30 is present (i.e., a space made up of the compression space, the cooler 45, the regenerator 46, the heater 47 and the expansion space). Specifically, in this embodiment, the bypass pipe 72 provides communication between the expansion space and the interior of the crankcase 120. Therefore, more concretely, the decompression valve 71 allows the working fluid that flows back and forth between the cylinder units 20 and 30 to move back and forth between the expansion space and the inside of the crankcase 120. The decompression valve 71 provided in the bypass pipe 72, besides being able to provide communication between the inside of the crankcase 120 and the working space (the expansion space in this example) in which the working fluid that flows back and forth between the cylinder units 20 and 30 is present, also serves as change means capable of changing the state of communication when communication is provided between the working space and the inside of the crank case 120. Therefore, the decompression effect can be weakened by the change means. In conjunction with this respect, the decompression valve 71 may be a flow amount adjustment valve capable of adjusting the degree of opening of the valve, and concretely in this embodiment, a butterfly valve is used as the decompression valve 71.

The Stirling engine 10 includes the ECU 80. The ECU 80 includes a microcomputer made up of a CPU, a ROM, a RAM, etc., and also includes an input/output circuit. The ECU 80 is electrically connected to various sensors/switches and the like, for example, a rotational speed N_{SE} detection sensor 91 for detecting the rotational speed N_{SE} of the Stirling engine 10, a pressure sensor 92 for detecting the pressure inside the crankcase 120, an exhaust gas temperature sensor 93 for detecting the exhaust gas temperature Tᵢₙ immediately prior to heat exchange of the exhaust gas with the heater 47, etc. In addition, the ECU 80 is also electrically connected to various control objects, such as the pressurizing pump 61, the pressurization-purpose open-close valve 63, the decompression valve 71, etc.

The programs in which various processes that the CPU executes are described and also for storing map data, etc are store in ROM. In the ECU 80, various control means, determination means, detection means, etc., may be implemented through processes executed by the CPU while utilizing a temporary storage area in the RAM according to need based on the programs stored in the ROM.

For example, in the ECU 80, the control means for controlling the decompression valve 71 so as to bring about the decompression effect when the engine is started. For bringing about the decompression effect, the control means is realized, concretely, so as to control the decompression valve 71 so that the valve 71 opens and, more concretely, so as to control the decompression valve 71 so that the degree of opening thereof becomes a fully open degree. Besides, for discontinuing the decompression effect, the control means is realized so as to control the decompression valve 71 so that after the engine is started, the decompression effect is gradually weakened, that is, the valve 71 is gradually closed. Specifically, the control means is realized so as to control the decompression valve 71 so that the decompression effect is gradually weakened, in the case where the rotational speed N_{SE} of the Stirling engine 10 has reached a starting rotational speed (i.e. a minimum rotational speed that is needed for the self-sustaining operation of the Stirling engine 10).

Besides, for gradually weakening the decompression effect, the control means is, concretely, realized so as to firstly control the decompression valve 71 so that the degree of opening of the decompression valve 71 reaches an intermediate degree of opening, and then control the decompression valve 71 so that the decompression valve 71 changes gradually from the state of the intermediate degree of opening to a fully closed state. Concretely, the intermediate degree of opening is a degree of opening at which the decompression effect may be maintained without the occurrence of torque fluctuations in the Stirling engine 10 in excess of the permissible torque fluctuation range once self-sustaining operation of the Stirling engine 10 has started. The torque fluctuation remains within a permissible torque fluctuation range, for example, at the time of a predetermination operation. The predetermination operation is, concretely, an operation that the Stirling engine 10 performs after starting the self-sustaining operation subsequent to the start of the engine. More concretely in this embodiment, the predetermined operation is a rated operation that produces a rated output that is rated as a guaranteed limit in use. The intermediate degree of opening of the decompression valve 71 is set at a degree of opening at which the aperture of the decompression valve 71 exceeds the aperture provided by the small clearances formed between the pistons 21 and 31 and the cylinders 22 and 32.

Furthermore, for gradually weakening and discontinuing the decompression effect, the control means is realized so as to control the decompression valve 71 so that the decompression valve 71 reaches a fully closed state after a predetermined time t1 has elapsed after the control means begins controlling the decompression valve 71 so as to gradually weakening the decompression effect (concretely, in this example, after the control means has controlled the decompression valve 71 so that the degree of opening of the decompression valve 71 reaches the intermediate degree of opening). In conjunction with this respect, the predetermined time t1 is pre-set at a length of time that is needed in order to prevent the torque fluctuation of the Stirling engine 10 from exceeding the permissible torque fluctuation when the decompression effect is to be gradually weakened to the discontinuation of the decompression effect. Then, in order to prevent the torque fluctuation of the Stirling engine 10 from exceeding the permissible torque fluctuation, the predetermined time t1 is pre-set according to the rotational speed N_{SE} of the Stirling engine 10. In conjunction with this respect, in setting the intermediate degree of opening of the decompression valve 71 at a degree of opening at which the decompression effect can be maintained without allowing the torque fluctuation to exceed the permissible torque fluctuation, the intermediate degree of opening can also be pre-set according to the rotational speed N_{SE} of the Stirling engine 10.

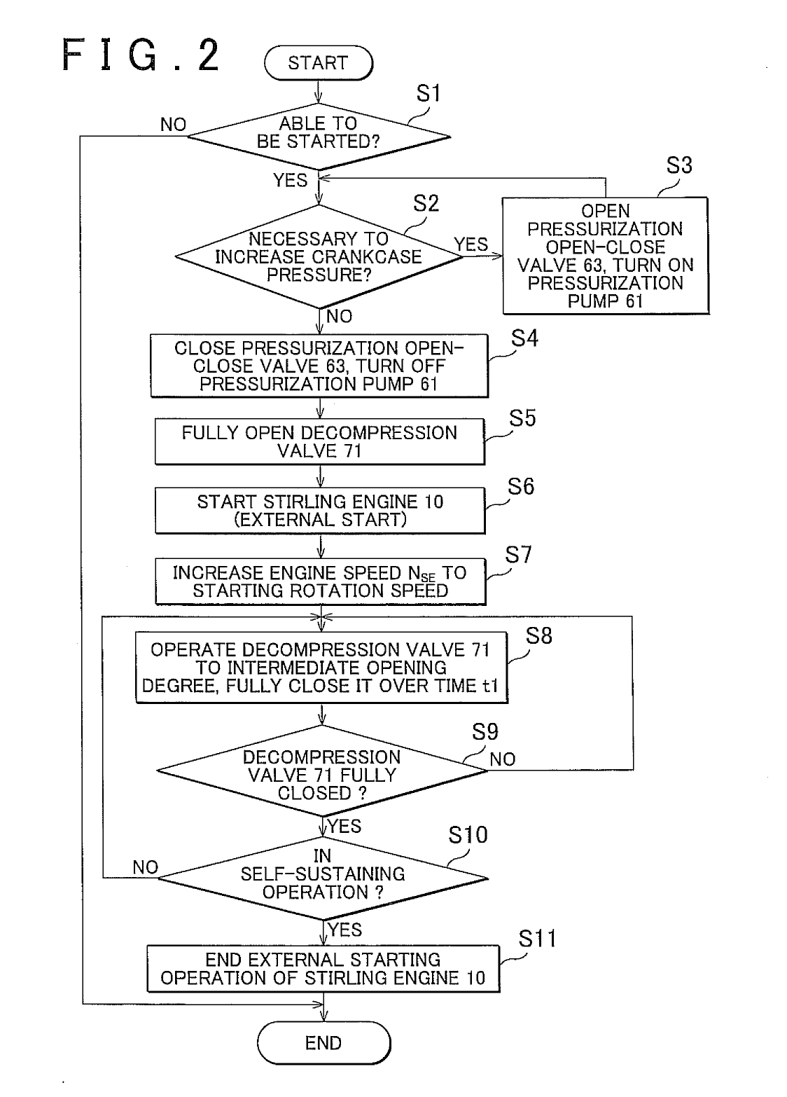

Next, an operation executed by the ECU 80 will be described with reference to a flowchart shown in FIG. 2. The ECU 80 determines whether it is possible to start the Stirling engine 10 (step S1). Whether it is possible to start the Stirling engine 10 may be determined, for example, by determining whether the exhaust gas temperature Tᵢₙ is higher than a predetermined temperature that is pre-set as a temperature that allows the self-sustaining operation of the Stirling engine 10. The self-sustaining operation of the Stirling engine 10 becomes feasible when the state of the working fluid receiving heat at the heater 47 is such that the Stirling engine 10 is able to produce output by overcoming the internal friction thereof and the inertia mass of the drive system. If a negative determination is made in step S1, it means that the Stirling engine 10 cannot be started, and the process of the flowchart is temporarily ended.

On the other hand, if an affirmative determination is made in step S1, it means that the Stirling engine 10 can be started. In this case, the ECU 80 determines whether the crankcase pressure needs to be increased by the pressurization (step S2). Concretely, on the basis of the output of the pressure sensor 92, the ECU 80 determines whether the crankcase pressure is smaller than a predetermined pressure. If the crankcase pressure is smaller than the predetermined pressure, the ECU 80 determines that pressurization is needed in order to increase the crankcase pressure. If an affirmative determination is made in step S2, the ECU 80 opens the pressurization-purpose open-close valve 63, and turns on the pressurizing pump 61 (step S3). Thus, the pressurization of the inside of the crankcase 120 is started. On the other hand, if a negative determination is made in step S2, the ECU 80 closes the pressurization-purpose open-close valve 63, and turns off the pressurizing pump 61 (step S4).

Subsequently, the ECU 80 fully opens the decompression valve 71 (step S5). Then, the ECU 80 starts the Stirling engine 10 by an external start (step S6). The Stirling engine 10 can be started by the external start, for example, by driving the crankshaft 113 through the use of power from the motive power source, such as an engine, an electric motor, etc., and thereby causing the pistons 21 and 31 to reciprocate. Since prior to step S6, the decompression valve 71 is fully opened in step S5, the decompression effect can be obtained when the Stirling engine 10 is started.

Subsequently to step S6, the ECU 80 increases the rotational speed N_{SE} of the Stirling engine 10 to the starting rotational speed (step S7). Subsequently, the ECU 80 closes the decompression valve 71 so that the degree of opening of the decompression valve 71 reaches the intermediate degree of opening, and then gradually closes the decompression valve 71 to the fully closed state over the predetermined time t1 (i.e., at a closing rate that is slower than the closing rate at which the degree of opening of the decompression valve 71 is reduced to the intermediate degree of opening) (step S8). Subsequently, the ECU 80 determines whether the decompression valve 71 is fully closed (step S9). If a negative determination is made in step S9, the process returns to step S8. However, if an affirmative determination is made in step S9, the ECU 80 then determines whether the Stirling engine 10 is in the self-sustaining operation (step S10). It is possible to determine whether the Stirling engine 10 is in the self-sustaining operation, for example, on the basis of whether the rotational speed N_{SE} of the Stirling engine 10 has exceeded the starting rotational speed while the decompression valve 71 is in the fully closed state. If a negative determination is made in step S10, the process returns to step S8. However, if an affirmative determination is made in step S10, the ECU 80 ends the external start operation of the Stirling engine 10 (step S11).

Next, operation and effect of the ECU 80 will be described. It is to be noted herein that the Stirling engine 10 is constructed so that at the time of starting the engine, the decompression effect is obtained by opening the decompression valve 71 to allow the working fluid to move between the working space and the interior of the crankcase 120. Therefore, due to the decompression effect, the Stirling engine 10 is able to restrain the starting torque, so that the crankshaft 113 may be driven with a reduced power in order to start the Stirling engine 10. In contrast, to discontinue the decompression effect, the ECU 80 controls the decompression valve 71 so as to gradually weaken the decompression effect after the Stirling engine 10 is started. Therefore, the ECU 80 is able to prevent or restrain the occurrence of a torque fluctuation that exceeds the permissible torque fluctuation.

To gradually weaken the decompression effect, the decompression valve 71 may also be controlled so that the open valve 71 is gradually closed. However, the ECU 80 first controls the decompression valve 71 so that the degree of opening of the decompression valve 71 decreases to an intermediate degree of opening, so that the decompression effect can be reduced in an earlier stage and to a greater extent, and therefore the output can be quickly increased. Besides, in this case, since the intermediate degree of opening of the decompression valve 71 is set at a degree of opening at which the decompression effect can be maintained without allowing the torque fluctuation to exceed the permissible torque fluctuation, the ECU 80 is able to prevent a torque fluctuation greater than the permissible torque fluctuation from occurring when the degree of opening of the decompression valve 71 is changed to the intermediate degree of opening, and is also able to cause the decompression effect to be more effectively realized by setting the intermediate degree of opening at a degree of opening at which the aperture of the decompression valve 71 exceeds the aperture provided by the small clearances that are formed between the pistons 21 and 31 and the cylinders 22 and 32. Besides, since, to gradually weaken the decompression effect to the discontinuation, the ECU 80 gradually closes the decompression valve 71 to the full closure over the predetermined time t1 after the ECU 80 has begun to weaken the decompression effect, it is possible to more certainly prevent a torque fluctuation greater than the permissible torque fluctuation from occurring when the decompression effect discontinues.

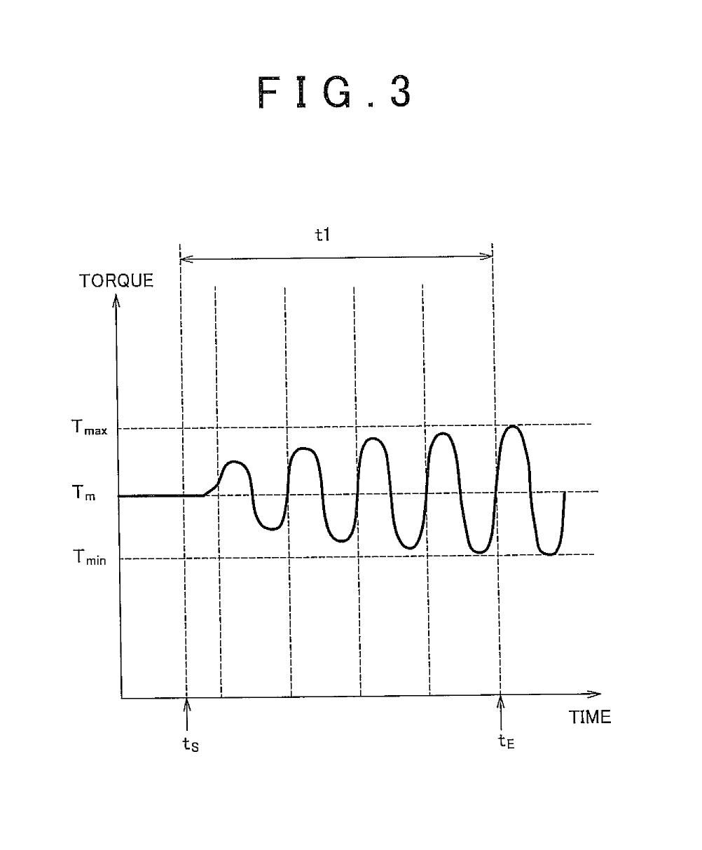

As a result of the ECU 80 preventing the torque fluctuation in this manner, the Stirling engine 10 has torque fluctuation as shown in FIG. 3. As shown in FIG. 3, as the degree of opening of the decompression valve 71 is changed to the intermediate degree of opening at a discontinuation start time T_{S} and the decompression valve 71 is gradually closed to the fully closed state over the predetermined time t1 between the discontinuation start time T_{S} and a discontinuation end time T_{E}, the torque fluctuations gradually increase within a permissible torque fluctuation (within a range between a maximum torque Tₘₐₓ and a minimum torque Tₘᵢₙ with an average torque Tₘ being the middle point therebetween) starting at the time T_{S}. At the time T_{E}, the torque fluctuations no longer increase and remains within the permissible torque fluctuation range. That is, concretely, in conjunction with the discontinuation of the decompression effect, the ECU 80 is able to prevent the occurrence of a torque fluctuation that exceeds the permissible torque fluctuation.

The above embodiment is simply an example embodiment of the invention. The invention is not restricted to the particular of the above embodiment, but may be carried out with various modifications and the like without departing from the gist of the invention. For example, the above embodiment is preferable in that the decompression effect can be more effectively utilized in the gradual weakening of the decompression effect. Therefore, the embodiment is described above in conjunction with the case where when the rotational speed N_{SE} of the Stirling engine 10 reaches the starting rotational speed, the decompression valve 71 is controlled so that the degree of opening of the decompression valve 71 reaches the intermediate degree of opening, and then the decompression valve 71 is gradually closed from the intermediate degree of opening to the fully closed state over the predetermined time t1. However, the invention is not necessarily restricted to this. Instead, the control means may control the decompression means so that the decompression effect begins to be gradually weakened at an appropriate rotational speed of the Stirling engine 10 after the torque passes the first ridge of torque fluctuation that occurs following the start of the Stirling engine.

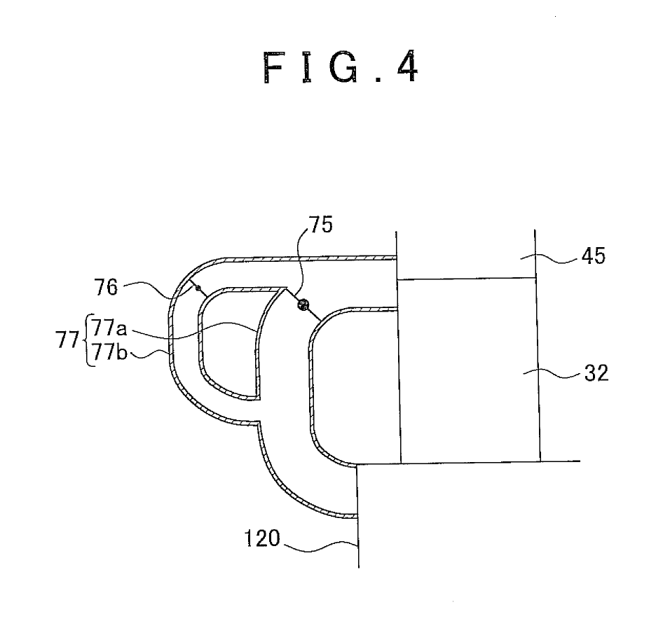

Besides, the embodiment is described above in conjunction with the case where the decompression means is the decompression valve 71. However, the invention is not necessarily limited to this, but the decompression means may also include, for example, a plurality of valves as shown in FIG. 4 (two valves in the example shown in FIG. 4), that is, a main valve 75 and a secondary valve 76. FIG. 4 shows portions of a modification of the Stirling engine 10 of the embodiment in which the decompression valve 71 and the bypass pipe 72 are replaced with valves 75 and 76 and a multi-step bypass pipe 77. The multi-step bypass pipe 77 is multi-step bypass means that has a multi-step construction of a plurality of pipes that form a bypass route in providing communication between the interior of a crankcase 120 and a working space (concretely, a cooler 45 and an expansion space). Specifically, the plurality of pipes include a main pipe 77a and a secondary pipe 77b in the example shown in FIG. 4. The main valve 75 and the secondary valve 76 are provided in an intermediate portion of the main pipe 77a and an intermediate portion of the secondary pipe 77b, respectively. The main pipe 77a forms a larger flow path than the secondary pipe 77b.

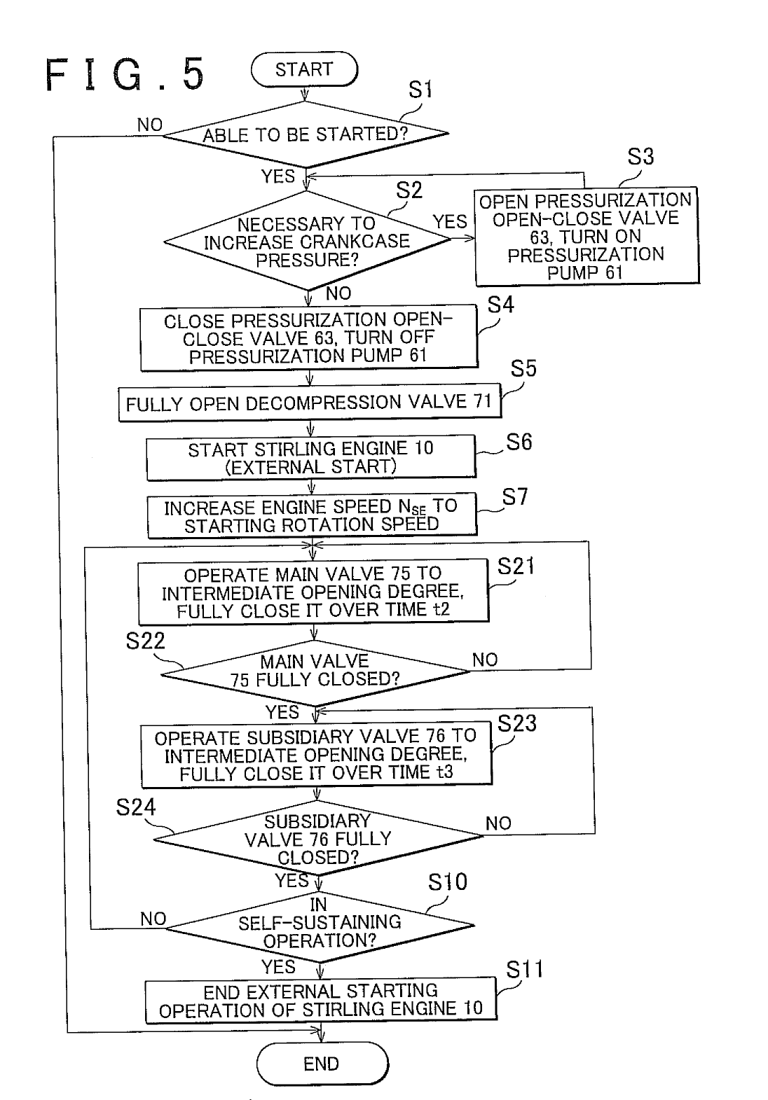

In this modification, the two valves 75 and 76 may be flow amount adjustment valves whose degree of opening can be adjusted. In such a case, the decompression effect can be discontinued, for example, as shown in FIG. 5. A flowchart shown in FIG. 5 is substantially the same as the flowchart shown in FIG. 3, except that steps S8 and S9 are replaced with steps S21 to S24. Besides, in this modification, the ECU 80 is electrically connected to the valves 75 and 76 as control objects instead of the decompression valve 71, and control means is functionally realized so as to perform a control as shown in FIG. 5 in the controlling of the valves 75 and 76.

As shown in FIG. 5, next in step S7, the ECU 80 controls the main valve 75 so that the degree of opening of the main valve 75 reaches an intermediate degree of opening, and then gradually closes the main valve 75 from the intermediate degree of opening to a fully closed state (at a closing rate that is slower than the closing rate at which the degree of opening of the main valve 75 is reduced to the intermediate degree of opening) over a predetermined time t2 (step S21). With respect to the main valve 75, the intermediate degree of opening and the predetermined time t2 may be similarly pre-set to the intermediate degree of opening and the predetermined time t1 regarding the decompression valve 71. Next, the ECU 80 determines whether the main valve 75 is fully closed (step S22). If the determination is negative, the process returns to step S21. If the determination is affirmative, the ECU 80 controls the secondary valve 76 so that the degree of opening of the secondary valve 76 reaches an intermediate degree of opening, and then gradually closes the secondary valve 76 from the intermediate degree of opening to the fully closed state (at a closing rate that is slower than the closing rate at which the degree of opening of the secondary valve 76 is reduced to the intermediate degree of opening) over a predetermined time t3 (step S23). With regard to the secondary valve 76, the intermediate degree of opening and the predetermined time t3 can be pre-set similarly to the intermediate degree of opening and the predetermined time t1 regarding the decompression valve 71. Next, the ECU 80 determines whether the secondary valve 76 is fully closed (step S24). If the determination is negative, the process returns to step S23. If the determination is affirmative, the process proceeds to step S10. In this modification, too, the decompression effect is not instantaneously discontinued, but is gradually weakened to the discontinuation, so that it is possible to prevent torque fluctuations in excess of the permissible torque fluctuation from occurring in association with the discontinuation of the decompression effect.

Alternatively, instead of implementing the control means by the ECU 80 in the above embodiment may be implemented through hardware, such as an electronic control unit other than that described above, a dedicated electronic circuit, etc., or by any combination of such components.

What is claimed is:

1. A control device for a Stirling engine including: two cylinder units; and a decompression portion that brings about a decompression effect of reducing a degree of compression of a working fluid that flows back and forth between the two cylinder units, by letting out the working fluid that flow back and forth between the two cylinder units, when the Stirling engine is started; the control device comprising
a control portion that controls the decompression portion so that the decompression effect is gradually weakened after the Stirling engine is started.

2. The control device according to claim 1, wherein:
the two cylinder units are high-temperature cylinder unit that includes a high-temperature cylinder and a high-temperature piston that is gas-lubricated with respect to the high-temperature cylinder, and a low-temperature cylinder unit that includes a low-temperature cylinder and a low-temperature piston that is gas-lubricated with respect to the low-temperature cylinder;
the Stirling engine includes a crankcase that is provided with a crankshaft that converts reciprocating motion of the high-temperature piston and the low-temperature piston into rotational motion, and a pressurization portion that pressurizes the interior of the crankcase; and
the decompression portion causes the working fluid that flows back and forth between the two cylinder units to move into and back from the interior of the crankcase.

3. The control device according to claim 1, wherein:
the decompression portion includes a bypass pipe that allows the working fluid that flows back and forth between the two cylinder units to move into and back from the interior of the crankcase, and a decompression valve that is provided at an intermediate portion of the bypass pipe; and
after the Stirling engine is started, the control portion executes a control that a degree of opening of the decompression valve reaches an intermediate degree of opening, and then gradually closes the decompression valve.

4. The control device according to claim 3, wherein the intermediate degree of opening is a degree of opening that is pre-set as a degree of opening at which the decompression effect is maintained without allowing the torque fluctuation of the Stirling engine to exceed a permissible torque fluctuation when the Stirling engine starts a self-sustaining operation.

5. The control device according to claim 3, wherein:
the Stirling engine includes a plurality of decompression portions;
the decompression portion includes a first decompression portion that has a bypass pipe, and a second decompression portion that has a bypass pipe that forms a smaller flow path than the bypass pipe of the first decompression portion; and
the control portion closes the decompression valve of the second decompression portion after closing the decompression valve of the first decompression portion.

6. A control device for a Stirling engine including: two cylinder units made up of a high-temperature cylinder unit that includes a high-temperature cylinder and a high-temperature piston that is gas-lubricated with respect to the high-temperature cylinder, and a low-temperature cylinder unit that includes a low-temperature cylinder and a low-temperature piston that is gas-lubricated with respect to the low-temperature cylinder; a crankcase provided with a crankshaft that converts reciprocating motion of the high-temperature piston and the low-temperature piston into rotational motion; a communication portion that communicates the interior of the crankcase with a working space in which a working fluid that flows back and forth between the two cylinder units is present; and a flow amount adjustment valve that is interposed in the communication portion; the control device comprising
a control portion that executes a control to open the flow amount adjustment valve when the Stirling engine is being started, and to gradually close the flow amount adjustment valve after the Stirling engine is started.
